(19) United States
(12) Patent Application Publication
(10) Pub. No.: US 2010/0265578 A1
(43) Pub. Date: Oct. 21, 2010

(54) IMAGE SHEET, ALIGNMENT METHOD AND APPARATUS

(76) Inventor: Yasunobu KAYANUMA, Kurokawa-gun (JP)

Correspondence Address: BIRCH STEWART KOLASCH & BIRCH, PO BOX 747, FALLS CHURCH, VA, 22040-0747, US

(21) Appl. No.: 12/762,034

(22) Filed: Apr. 16, 2010

(30) Foreign Application Priority Data
Apr. 17, 2009 (JP) 100594/2009
Apr. 17, 2009 (JP) 100595/2009

(51) Int. Cl. G02B 27/22

(52) U.S. Cl. 359/463

(57) ABSTRACT

An image sheet to be provided with a composite image which can be viewed stereoscopically or changeably when bonded to a lenticular sheet having a plurality of cylindrical lenses arranged in parallel, the composite image including a plurality of image units arranged side by side, each corresponding to each of the cylindrical lenses and having a plurality of strip-like images. The image sheet includes an image area to be provided with the composite image and a pattern area to be provided with at least one first adjustment pattern and at least one second adjustment pattern for aligning the image sheet with the lenticular sheet in a rotational direction and a pitch direction, in which the image units are arranged, respectively.

### BACKGROUND OF THE INVENTION

1. Field of the Invention

The present invention relates to an image sheet having a composite image which can be viewed stereoscopically or changeably when bonded to a lenticular sheet, and an alignment method and apparatus for aligning the image sheet with the lenticular sheet.

2. Description of the Related Art

It is known that stereoscopic vision using parallax is possible by combining a plurality of images and representing them three-dimensionally. Such stereoscopic vision is possible by photographing the same subject from different positions using a plurality of cameras to obtain a plurality of images having parallaxes (parallax images) and three-dimensionally displaying the plurality of images through the use of the parallaxes of the subject included in the parallax images.

Here, lenticular printing is known as a method for three-dimensionally displaying images. A lenticular print may be produced in the following manner: generating a composite image by vertically cutting a plurality of parallax images in strips obtained by a compound eye camera having a plurality of photographing units and alternately disposing the strip-like images, creating an image sheet by printing the composite image on a printing paper, aligning image units, which are a plurality of strip-like images cut from a plurality of parallax images, with individual cylindrical lenses of the lenticular sheet, and bonding the image sheet and lenticular sheet together. In addition to the lenticular sheet for stereoscopic vision, a lenticular sheet that allows changing in which different images can be viewed by changing the viewing angle is also known.

In such a lenticular sheet that allows stereoscopic vision or the like, image units of a plurality of strip-like images cut from a plurality of parallax images (in the case of stereoscopic vision) and individual cylindrical lenses of the lenticular sheet should be aligned precisely with each other, otherwise the stereoscopic representation or image change is not visually recognizable. More specifically, the alignment should be performed such that the longitudinal direction of cylindrical lenses of the lenticular sheet corresponds to the longitudinal direction of unit images of the composite image, and only one unit image lies in each cylindrical lens. Consequently, the following alignment methods and the like are proposed: a method that performs the alignment by viewing a straight line formed on the composite image as described, for example, in Japanese Unexamined Patent publication No. 11 (1999)-015086; a method that performs the alignment by respectively forming concave and convex shapes on the image sheet and lenticular sheet and fitting them together as described, for example, in Japanese Unexamined Patent Publication No. 10 (1998)-123633; a method that performs the alignment by forming a gauge area for aligning with an area of the composite image and using moiré in the gauge area as described, for example, in Japanese Unexamined Patent publication No. 11 (1999)-352441; and a method that performs the alignment using a frame as described, for example, in Japanese Unexamined Patent Publication No. 2001-075200.

The method described in Japanese Unexamined Patent publication No. 11 (1999)-015086 has low alignment accuracy because the alignment is performed simply by viewing the straight line and is not suitable for automatic alignment. The method described in Japanese Unexamined Patent Publication No. 10 (1998)-123633 needs to form concave and convex shapes on the image sheet and lenticular sheet, requiring equipment for that purpose. The method described in Japanese Unexamined Patent publication No. 11 (1999)-352441 is unable to align the image sheet with the lenticular sheet in a rotational direction. The method described in Japanese Unexamined Patent Publication No. 2001-075200 requires the frame.

Further, the image sheet and lenticular sheet are, in general, very thin. Consequently, when performing the alignment, it is difficult to move the image sheet relative to lenticular sheet placed on top of each other by any of the methods described above.

The present invention has been developed in view of the circumstances described above, and it is an object of the present invention to provide a simple structure capable of accurately aligning an image sheet with a lenticular sheet when making a lenticular print by bonding the image sheet and lenticular sheet together.

It is another object of the present invention to enable easy alignment of an image sheet with a lenticular sheet.

### SUMMARY OF THE INVENTION

A first image sheet of the present invention is an image sheet to be provided with a composite image which can be viewed stereoscopically or changeably when bonded to a lenticular sheet having a plurality of cylindrical lenses arranged in parallel, the composite image including a plurality of image units arranged side by side, each corresponding to each of the cylindrical lenses and having a plurality of strip-like images, wherein the image sheet includes:

an image area to be provided with the composite image; and

a pattern area to be provided with at least one first adjustment pattern and at least one second adjustment pattern for aligning the image sheet with the lenticular sheet in a rotational direction and a pitch direction, in which the image units are arranged, respectively.

The term “a rotational direction” as used herein refers to a rotational direction around an axis perpendicular to the surfaces of an image sheet of the present invention and a lenticular sheet when the image sheet and the lenticular sheet are stacked top of each other.

In the first image sheet of the present invention, the first adjustment pattern may include a plurality of line segments arranged in the pitch direction and a pitch P1 of the line segments may satisfy, when the pitch of the image units is P0, the relationship of P0<P1<2·P0.

In this case, the pitch P1 of the line segments may be about 4/3 of the pitch P0 of the image units.

In the first image sheet of the present invention, the second adjustment pattern may include a plurality of line segments arranged in the pitch direction with the same pitch as the image units at positions corresponding to substantially the centers of the image units, and a line width of each of the line segments may be about ½ of the pitch P0 of the image units.

Further, in the first image sheet of the present invention, the pattern area may be provided around the image area, and first and second adjustment patterns may be provided at positions on each side across the image area in a longitudinal direction of the image area.

In this case, the second adjustment pattern may be provided at a position on each side across the image area in a direction orthogonal to the longitudinal direction.

Still further, in the first image sheet of the present invention, the pattern area may be divided into two areas across the image area in the longitudinal direction of the image area, and the first and second adjustment patterns may be provided in each of the two areas.

The term “divided into two areas across the image area in the longitudinal direction” as used herein refers to that one divided area, the image area, and the other divided area are arranged in this order in the longitudinal direction of the image area.

In the first image sheet of the present invention, the first and second adjustment patterns may be assigned different colors.

A first alignment apparatus of the present invention is an apparatus for aligning the first image sheet of the present invention with a lenticular sheet having a plurality of cylindrical lenses arranged in parallel, the apparatus including:

a photographing unit for photographing an image of the first adjustment pattern appeared on the lenticular sheet stacked on the image sheet;

a detection unit for detecting an angle of the line segments with respect to a longitudinal direction of the image units in the image of the first adjustment pattern obtained by the photographing; and

a moving unit for rotating the lenticular sheet with respect to the image sheet such that the angle is reduced to a minimum to align the image sheet with the lenticular sheet in the rotational direction.

In the first alignment apparatus of the present invention, the photographing unit may be a unit that photographs an image of the second adjustment pattern appeared on the lenticular sheet stacked on the image sheet after the alignment in the rotational direct, the detection unit may be a unit that detects a density of the line segments in the image of the second adjustment pattern obtained by the photographing, and the moving unit may be a unit that moves the lenticular sheet with respect to the image sheet in a pitch direction of the cylindrical lenses such that the density is increased to a maximum to align the image sheet with the lenticular sheet in the pitch direction.

A first alignment method of the present invention is a method for aligning the first image sheet of the present invention with a lenticular sheet having a plurality of cylindrical lenses arranged in parallel, the method including the steps of:

photographing an image of the first adjustment pattern appeared on the lenticular sheet stacked on the image sheet;

detecting an angle of the line segments with respect to a direction in which the image units extend in the image of the first adjustment pattern obtained by the photographing; and

rotating the lenticular sheet with respect to the image sheet such that the angle is reduced to a minimum to align the image sheet with the lenticular sheet in the rotational direction.

A second image sheet of the present invention is an image sheet to be provided with a composite image which can be viewed stereoscopically or changeably when bonded to a lenticular sheet having a plurality of cylindrical lenses arranged in parallel, the composite image including a plurality of image units arranged side by side, each corresponding to each of the cylindrical lenses and having a plurality of strip-like images, wherein the image sheet includes:

an image area to be provided with the composite image; and

a pattern area to be provided over the entire surface with an adjustment pattern for aligning the image sheet with the lenticular sheet.

In the second image sheet of the present invention, the adjustment pattern may include a plurality of line segments arranged in the pitch direction with the same pitch as the image units at positions corresponding to substantially the centers of the image units, and a line width of each of the line segments is about ½ of the pitch P0 of the image units.

A second alignment apparatus of the present invention is an apparatus for aligning the second image sheet of the present invention with a lenticular sheet having a plurality of cylindrical lenses arranged in parallel, the apparatus including:

a photographing unit for photographing an image of the adjustment pattern appeared on the lenticular sheet stacked on the image sheet;

a detection unit for detecting a high frequency component of the image of the adjustment pattern obtained by the photographing; and

a moving unit for rotating the lenticular sheet with respect to the image sheet such that the high frequency component is reduced to a minimum to align the image sheet with the lenticular sheet in the rotational direction.

In the second alignment apparatus of the present invention, the photographing unit may be a unit that photographs an image of the adjustment pattern appeared on the lenticular sheet stacked on the image sheet after the alignment in the rotational direct, the detection unit may be a unit that detects a density of the line segments in the image of the adjustment pattern obtained by the photographing, and the moving unit may be a unit that moves the lenticular sheet with respect to the image sheet in a pitch direction of the cylindrical lenses such that the density is increased to a maximum to align the image sheet with the lenticular sheet in the pitch direction.

A second alignment method of the present invention is a method for aligning the second image sheet of the present invention with a lenticular sheet having a plurality of cylindrical lenses arranged in parallel, the method including the steps of:

photographing an image of the adjustment pattern appeared on the lenticular sheet stacked on the image sheet;

detecting a high frequency component of the image of the adjustment pattern obtained by the photographing; and

rotating the lenticular sheet with respect to the image sheet such that the high frequency component is reduced to a minimum to align the image sheet with the lenticular sheet in the rotational direction.

According to the first image sheet of the present invention, the pattern area includes at least one first adjustment pattern and at least one second adjustment pattern for aligning the image sheet with a lenticular sheet in a rotational direction and a pitch direction, in which the image units are arranged, respectively. This allows the image sheet and the lenticular sheet to be aligned with each other accurately in a rotational direction and a pitch direction in which the image units are arranged by stacking the image sheet and lenticular sheet on top of each other and detecting the first and second adjustment patterns through the lenticular sheet. Further, as it is possible to photograph the first and second adjustment patterns, the alignment of the image sheet with lenticular sheet can be automated easily.

Further, if the first adjustment pattern includes a plurality of line segments arranged side by side in a pitch direction and if a pitch P1 of the line segments satisfies, when the pitch of the cylindrical lenses is P0, the relationship of P0<P1<2·P0, and more preferably, if pitch P1 is about 4/3 of pitch P0 of the cylindrical lenses, the angular displacement in a rotational direction between the image sheet and lenticular sheet may be detected by the inclination of line segments included in the first adjustment pattern viewed through the lenticular sheet. Consequently, the image sheet and the lenticular sheet may be aligned accurately with each other in a rotational direction by relatively rotating the image sheet and the lenticular sheet such that the inclination of the detected line segments becomes 0 with respect to a direction orthogonal to a pitch direction of the line segments.

Still further, if second adjustment pattern includes a plurality of line segments arranged in a pitch direction with the same pitch as image units at positions corresponding to substantially the centers of image units, and if line width of the line segments is set to about ½ of the pitch P0 of the image units, the displacement between the image sheet and the lenticular sheet in a pitch direction may be detected by the change in the density of the line segments included in the second adjustment pattern viewed through lenticular sheet. Consequently, the image sheet and the lenticular sheet may be aligned accurately with each other in a pitch direction by relatively moving the image sheet and the lenticular sheet such that the detected density becomes a maximum.

Further, by providing the pattern area around the image area and disposing the first and second adjustment patterns at positions on each side across the image area in a longitudinal direction thereof.

Still further, alignment accuracy in a pitch direction may further be improved by disposing the second adjustment pattern at a position on each side across the image area in a direction orthogonal to a longitudinal direction thereof.

Further, alignment accuracy in a rotational direction and a pitch direction may be improved by dividing the pattern area into two areas across the image area in a longitudinal direction of the image area and providing the first and second adjustment patterns in each of the two areas.

Still further, assignment of different colors to the first and second adjustment patterns allows the first and second adjustment patterns to be easily distinguished from each other when photographed, so that the alignment may be automated more easily.

According to the second image sheet of the present invention, an adjustment pattern for aligning the image sheet with a lenticular sheet is provided over the entire surface of the pattern area. This allows the image sheet and the lenticular sheet to be aligned accurately with each other by stacking the image sheet and lenticular sheet on top of each other and detecting the adjustment pattern through the lenticular sheet. Further, as it is possible to photograph the adjustment pattern, the alignment of the image sheet with lenticular sheet can be automated easily.

Further, when the adjustment pattern includes a plurality of line segments arranged in a pitch direction with the same pitch as image units at positions corresponding to substantially the centers of image units, and if line width of the line segments is set to about ½ of the pitch P0 of the image units, then a moiré pattern appears when the image sheet is viewed through the lenticular sheet if the image sheet is not aligned with the lenticular sheet in a rotational direction. Here, a greater displacement angle between the image sheet and the lenticular sheet results in a greater amount of high frequency component due to moiré. Consequently, the image sheet and the lenticular sheet may be aligned accurately with each other in a rotational direction by relatively rotating the image sheet and the lenticular sheet such that the moiré pattern disappears, i.e., such that the high frequency component is reduced to a minimum.

Further, the displacement between the image sheet and lenticular sheet in a pitch direction may be detected accurately by the change in the density of line segments included in the adjustment pattern viewed through the lenticular sheet. Consequently, the image sheet and the lenticular sheet may be aligned accurately with each other in a pitch direction by relatively moving the image sheet and the lenticular sheet such that the detected density is increased to a maximum.

A third alignment apparatus of the present invention is an apparatus for aligning a composite image, which can be viewed stereoscopically or changeably when bonded to a lenticular sheet having a plurality of cylindrical lenses arranged in parallel, with the lenticular sheet, the composite image including a plurality of image units arranged side by side, each corresponding to each of the cylindrical lenses and having a plurality of strip-like images, the apparatus including:

a support platform on which the image sheet and the lenticular sheet are placed in a stacked manner in this order;

a support member for supporting the image sheet and the lenticular sheet placed on the support platform from above; and

a moving unit for relatively moving the lenticular sheet with respect to image sheet by moving the support member,

wherein a friction coefficient between the support platform and the image sheet and a friction coefficient between the support member and the lenticular sheet are greater than a friction coefficient between the image sheet and the lenticular sheet.

Preferably, the support member is a plate-like member. In this case, it is preferable that the plate-like member is transparent to allow visual recognition of the lenticular sheet and the image sheet. Alternatively, an opening or a notch may be provided to allow visual recognition of the lenticular sheet and the image sheet. Further, the support member is not limited to a plate-like member, and any known member may be used as long as it is capable of supporting a lenticular sheet and an image sheet placed on the support platform from above moving the lenticular sheet with respect to the image sheet by moving the support member.

In the third alignment apparatus of the present invention, a high friction coefficient member may be attached to a surface of the support platform on which the image sheet is placed and a surface of the support member that contacts the lenticular sheet.

Further, the third alignment apparatus of the present invention may further include an auxiliary platform on which, together with the support platform, the image sheet is placed, and is capable of moving between a support position for supporting the image sheet and a withdrawal position away from the support platform.

In this case, the apparatus may further include a fixing unit for fixing the image sheet and the lenticular sheet to the support platform by pressing the image sheet and the lenticular sheet placed on the support platform by way of the support member.

In the third alignment apparatus of the present invention, the lenticular sheet may include an adhesive layer and a peel-off sheet for protecting the adhesive layer on the lower surface, and the image sheet and the lenticular sheet may be stacked on top of each other with the peel-off sheet facing the image sheet.

A third alignment method of the present invention is a method for aligning a composite image, which can be viewed stereoscopically or changeably when bonded to a lenticular sheet having a plurality of cylindrical lenses arranged in parallel, with the lenticular sheet, the composite image including a plurality of image units arranged side by side, each corresponding to each of the cylindrical lenses and having a plurality of strip-like images, the method including the steps of:

placing the image sheet and the lenticular sheet on a support platform by stacking them on top of each other in this order;

supporting the image sheet and the lenticular sheet placed on the support platform with a support member from above; and

relatively moving the lenticular sheet with respect to image sheet by moving the support member,

wherein a friction coefficient between the support platform and the image sheet, and a friction coefficient between the support member and the lenticular sheet are greater than a friction coefficient between the image sheet and the lenticular sheet.

According to the third alignment method and apparatus of the present invention, the image sheet and the lenticular sheet are stacked in this order and placed on the support platform. Then, the image sheet and the lenticular sheet placed on the support platform are supported by the support member from above. Here, in the present invention, a friction coefficient between the support platform and the image sheet, and a friction coefficient between the support member and the lenticular sheet are greater than a friction coefficient between the image sheet and the lenticular sheet. Consequently, any displacement between the support member and lenticular sheet or between the support platform and image sheet does not occur when the support member is moved. Consequently, while the image sheet is kept in a state of being fixed to the support platform, the lenticular sheet may be moved integrally with the support member with respect to the image sheet. Accordingly, the image sheet and the lenticular sheet may be aligned easily with each other with a simple configuration.

Still further, as a high friction coefficient member is bonded to a surface of the support platform on which the image sheet is placed and a surface of the support member that contacts the lenticular sheet, any displacement between the support member and the lenticular sheet or between the support platform and the image sheet may be reliably prevented.

Provision of the auxiliary platform on which, together with the support platform, the image sheet is placed, and is capable of moving between a support position for supporting the image sheet and a withdrawal position away from the support platform allows the image sheet and the lenticular sheet to be stably supported by moving the auxiliary platform to the support position when performing alignment. In addition, auxiliary platform may be moved to a withdrawal position after the alignment, and the image sheet and the lenticular sheet may be partially bonded at the position where the auxiliary platform was positioned, which may thus facilitate the partial bonding between the image sheet and the lenticular sheet.

Still further, the image sheet and the lenticular sheet placed on the support patform may be pressed by way of the support member to fix them on the support patform, so that any displacement between the image sheet and the lenticular sheet may be prevented when performing the partial bonding between them.

### BRIEF DESCRIPTION OF THE DRAWINGS

FIG. 1 is a plan view of an image sheet according to a first embodiment of the present invention.

FIG. 2 illustrates a structure of a lenticular sheet.

FIG. 3 is a drawing for explaining a composite image and alignment of the composite image with a lenticular sheet.

FIG. 4 illustrates a first adjustment pattern.

FIG. 5 is a drawing for explaining the pitch of line segments of the first adjustment pattern (part 1).

FIG. 6 is a drawing for explaining the pitch line segments of the first adjustment pattern (part 2).

FIG. 7 is a drawing for explaining the pitch of line segments of the first adjustment pattern (part 3).

FIG. 8 is a drawing for explaining the pitch of line segments of the first adjustment pattern (part 4).

FIG. 9 is a drawing for explaining detection of a displacement angle.

FIG. 10 illustrates a second adjustment pattern.

FIG. 11 is a drawing for explaining the line width of line segments in the second adjustment pattern (part 1).

FIG. 12 is a drawing for explaining the line width of line segments in the second adjustment pattern (part 2).

FIG. 13 is a drawing for explaining technical details of a cylindrical lens.

FIG. 14 illustrates technical details of two types of cylindrical lenses used in the present embodiment.

FIG. 15 is a schematic perspective view of an alignment apparatus of the present embodiment, illustrating the structure thereof.

FIG. 16 is a cross-sectional view taken along the line I-I in FIG. 15.

FIG. 17 is a view on arrow A in FIG. 15.

FIG. 18 illustrates a peel-off sheet.

FIG. 19 is a flowchart of an alignment process performed by an alignment apparatus in a first embodiment (part 1).

FIG. 20 is a flowchart of an alignment process performed by an alignment apparatus in a first embodiment (part 2).

FIG. 21 is a drawing for explaining movement of pins (part FIG. 22 is a drawing for explaining movement of pins (part 2).

FIG. 23 is a plan view of another embodiment of a pattern area.

FIG. 24 is a plan view of an image sheet according to a second embodiment of the present invention.

FIG. 25 is a flowchart of an alignment process performed by an alignment apparatus in a second embodiment.

FIG. 26 illustrates a moiré pattern.

### DESCRIPTION OF THE PREFERRED EMBODIMENTS

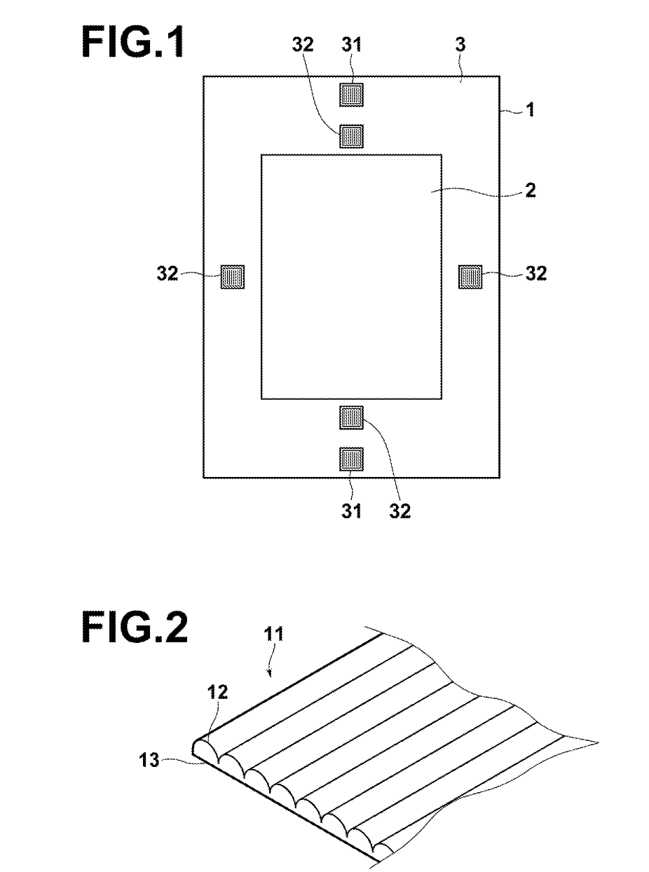

Hereinafter, embodiments of the present invention will be described with reference to the accompanying drawings. FIG. 1 is a plan view of an image sheet according to a first embodiment of the present invention. Image sheet 1 according to the first embodiment is used to make a lenticular print by bonding to a lenticular sheet for implementing stereoscopic vision or changing, and includes image area 2 on which a composite image, to be described later, is printed and pattern area 3 provided around the image area 2, as shown in FIG. 1. Pattern area 3 includes two first adjustment patterns 31 and four second adjustment patterns 32, provided by printing or the like, for aligning image sheet 1 with a lenticular sheet. First and second adjustment patterns 31, 32 will be described later.

FIG. 2 illustrates a structure of a lenticular sheet. As illustrated in FIG. 2, lenticular sheet 11 is formed of a plurality of cylindrical lenses 12 arranged side by side, each having a predetermined width and a substantially semi-cylindrical shape. Lenticular sheet 11 has a front surface on which convex portions of cylindrical lenses 12 are arranged and a planar rear surface 13 having no such convex portions.

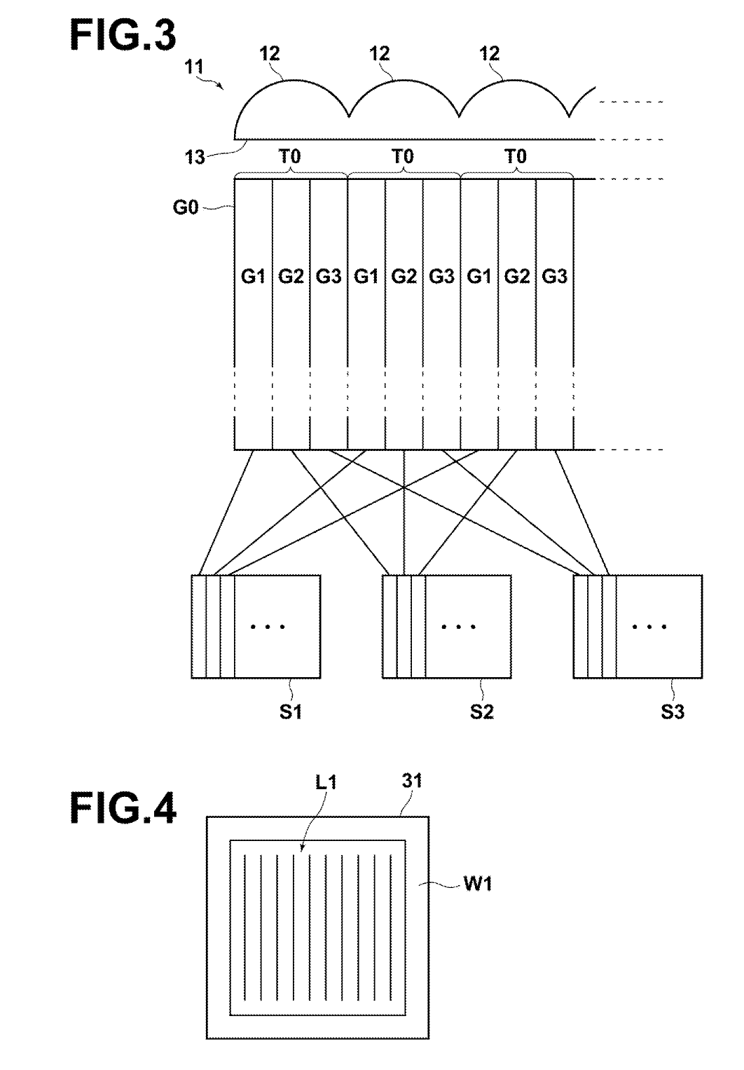

FIG. 3 is a drawing for explaining a composite image and alignment of the composite image with a lenticular sheet. Hereinafter, description will be made of a case in which the composite image is used for implementing stereoscopic vision, but it may be a composite image for implementing changing. As illustrated in FIG. 3, composite image G0 is created by vertically cutting a plurality of images in strips obtained by a compound eye camera having a plurality of photographing units and alternately disposing the strip-like images. For example, if the compound eye camera has three photographing units and images obtained by the three photographing units are designated as S1, S2, and S3, composite image G0 is created by alternately and repeatedly arranging strip-like patterns G1 to G3 obtained by cutting three images S1 to S3 in strips, as illustrated in FIG. 3.

Note that three patterns G1 to G3 constitute image unit T0 corresponding to one cylindrical lens 12 of lenticular sheet 11. Further, one image unit T0 constituted by three strip-like patterns G1 to G3 is produced such that the width thereof corresponds to the width of cylindrical lens 12 on lentidular sheet 11. The longitudinal direction of three strip-like patterns G1 to G3, that is, image unit T0 corresponds to the longitudinal direction of cylindrical lens 12.

Then, image sheet 1 is produced by printing composite image G0 in image area 2 and first and second adjustment patterns 31, 32 in pattern area 3.

Further, the longitudinal direction of one image unit T0 of composite image G0 is aligned with the longitudinal direction of cylindrical lens 12 to implement alignment in a rotational direction, and further alignment in a pitch direction is performed to fit each image unit T0 within the width of each cylindrical lens of lenticular sheet 11, and then lenticular sheet 11 and image sheet 1 are bonded together to produce a lenticular print.

Next, first and second adjustment patterns 31, 32 for implanting the alignment will be described. First adjustment pattern 31 will be described first. FIG. 4 illustrates first adjustment pattern 31. First adjustment pattern 31 is used to implement the alignment between image sheet 1 and lenticular sheet 11 in a rotational direction. The term “rotational direction” as used herein refers to a rotational direction around an axis perpendicular to surfaces of image sheet 1 and lenticular sheet 11 when image sheet 1 and lenticular sheet 11 are stacked on top of each other. As shown in FIG. 4, first adjustment pattern 31 includes frame W1 having a predetermined color (e.g., blue) and a plurality of line segments L1 arranged in the pitch direction of image units T0 of composite image G0. The term “pitch direction” as used herein refers to a direction in which image units T0 and cylindrical lenses are arranged side by side (i.e., a direction orthogonal to the longitudinal direction of image unit T0 and cylindrical lens 12.

The plurality of line segments L1 are arranged with a predetermined pitch P1. Here, if the pitch of image units T0 is P0, line segments L1 are disposed such that the relationship of P0<P1<2·P0 is satisfied, and more preferably such that pitch P1 substantially corresponds to 4/3 of P0. Hereinafter, pitch P1 of line segments L1 will be described.

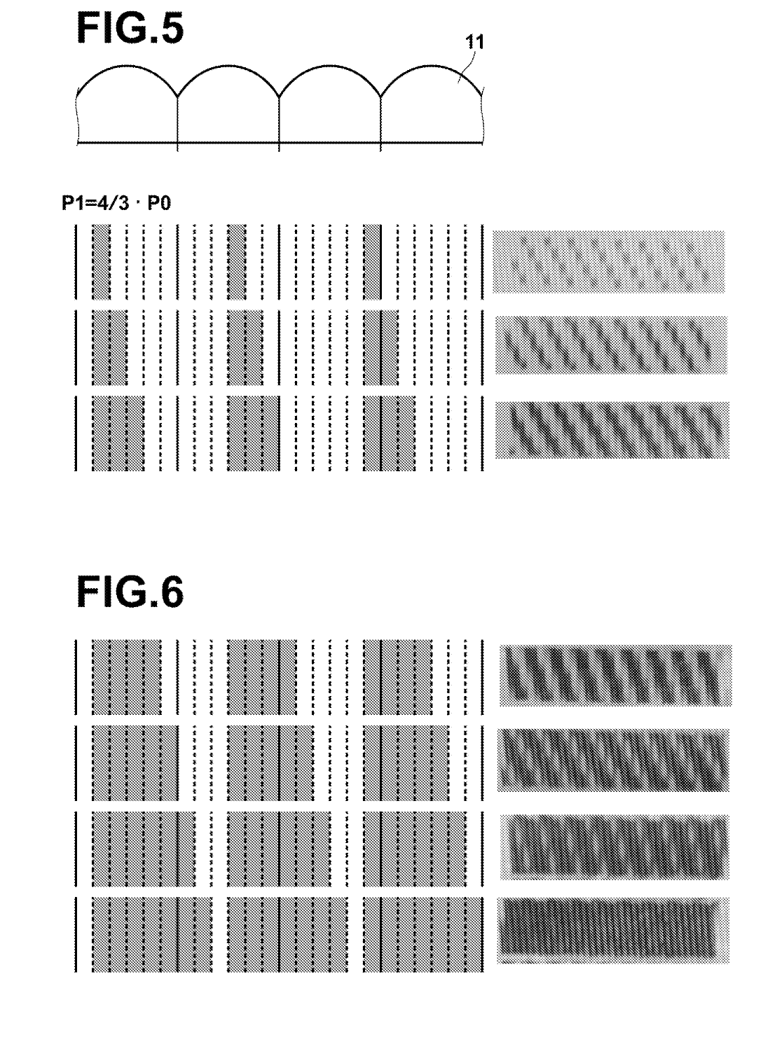

FIGS. 5 to 8 are drawings for explaining the pitch of line segments L1 of first adjustment pattern 31. In FIGS. 5 to 8, it is assumed that image unit T0 includes six strip-like patterns G1 to G6, and image sheet 1 and lenticular sheet 11 are not aligned in a rotational direction in order to facilitate the explanation. Further, a vertical direction in the drawings on the left side of FIGS. 5 to 8 corresponds to a longitudinal direction of image unit T0 and cylindrical lens 12, and solid lines represent delimiting lines of image units T0 and dotted lines represent delimiting lines of patterns within each image unit T0. Further, gray potions represent the line width of line segments L1. Drawings on the right side of FIGS. 5 to 8 show pattern images obtained by photographing first adjustment pattern 31 through lenticular sheet 11 with image sheet 1 and lenticular sheet 11 being placed on top of each other.

First, as shown in FIGS. 5 and 6, when pitch P1 of line segments L1 is set to 4/3 of pitch P0 of image units T0, line segments with an inclination according to a displacement angle between image sheet 1 and lenticular sheet 11 in a rotational direction appears in the pattern images regardless of the line width of line segments L1. Note that the line width is changeable from ⅙·P0 to 7/6·P0. Here, the angle of line segments appearing in the pattern images with respect to a vertical direction (i.e., longitudinal direction of image unit T0) indicates a displacement angle of lenticular sheet 11 with respect to image sheet 1, as illustrated in FIG. 9. That is, when lenticular sheet 11 is rotated by −θ degrees in the counterclockwise direction, line segments L1 are rotated by −θ degrees with respect to the vertical direction in the pattern image of first adjustment pattern 31, as illustrated in FIG. 9. Contrarily, when lenticular sheet 11 is rotated by θ degrees in the clockwise direction, line segments L1 are rotated by θ degrees with respect to the vertical direction in the pattern image of first adjustment pattern 31. Accordingly, when pitch P1 of line segments L1 is set to 4/3 of pitch P0 of image units T0, the displacement angle between image sheet 1 and lenticular sheet 11 in a rotational direction may be detected by the inclination line segments L1, regardless of the line width of line segments L1.

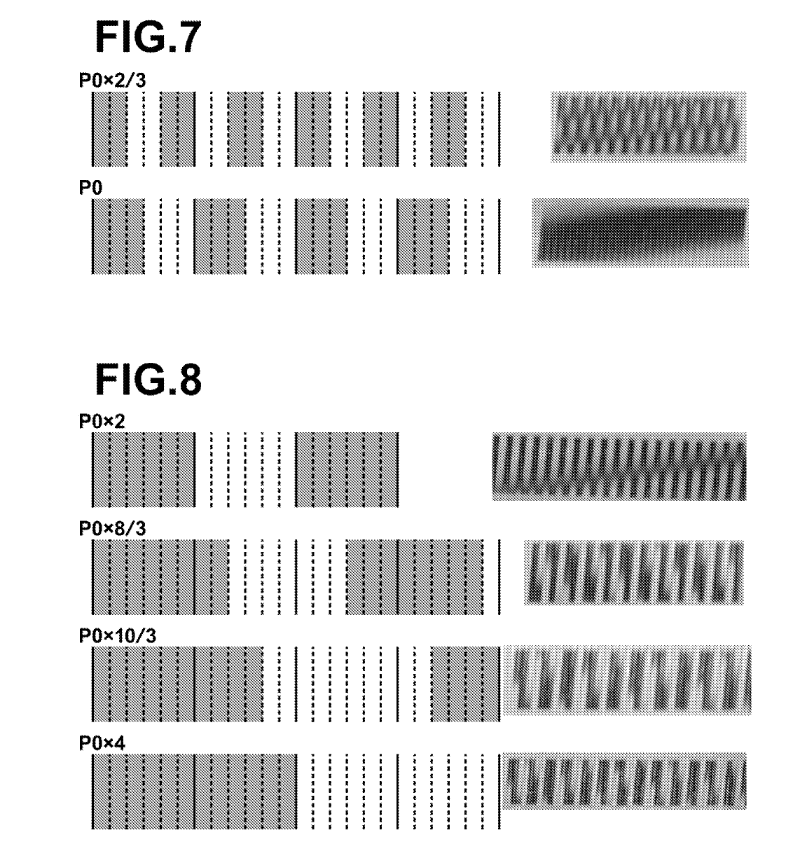

In the mean time, when pitch P1 of line segments L1 is set to ⅔ of pitch P0 of image units T0, line segments are too fine to be detected in the pattern images, as shown in FIG. 7. If pitch P1 of line segments L1 is set equal to pitch P0 of image units T0, only a moiré pattern appears. Further, when pitch P1 of line segments L1 is set to a value greater than two times of pitch P0 of image units T0, the inclination of line segments L1 can not be detected, as shown in FIG. 8.

Consequently, in the first embodiment, when the pitch of image units T0 is P0, first adjustment pattern 31 is formed such that the relationship of P0<P1<2·P0 is satisfied, and more preferably such that pitch P1 substantially corresponds to 4/3 of P0.

Note that, only one or not less than three first adjustment patterns 31 may be disposed. Here, it is preferable that first adjustment patterns 31 are disposed at positions separated as far apart as possible since they are used for detecting displacement between image sheet 1 and lenticular sheet 11 in a rotational direction. Consequently, in the present embodiment, first adjustment pattern 31 is disposed on each side across image area 2 in a longitudinal direction thereof, as illustrated in FIG. 1. Note that first adjustment patterns 31 may be disposed in a short axis direction of the image area 2.

The displacement angle between image sheet 1 and lenticular sheet 11 in a rotational direction may be detected by analyzing the pattern image of first adjustment pattern 31, but the displacement angle may also be visually confirmed.

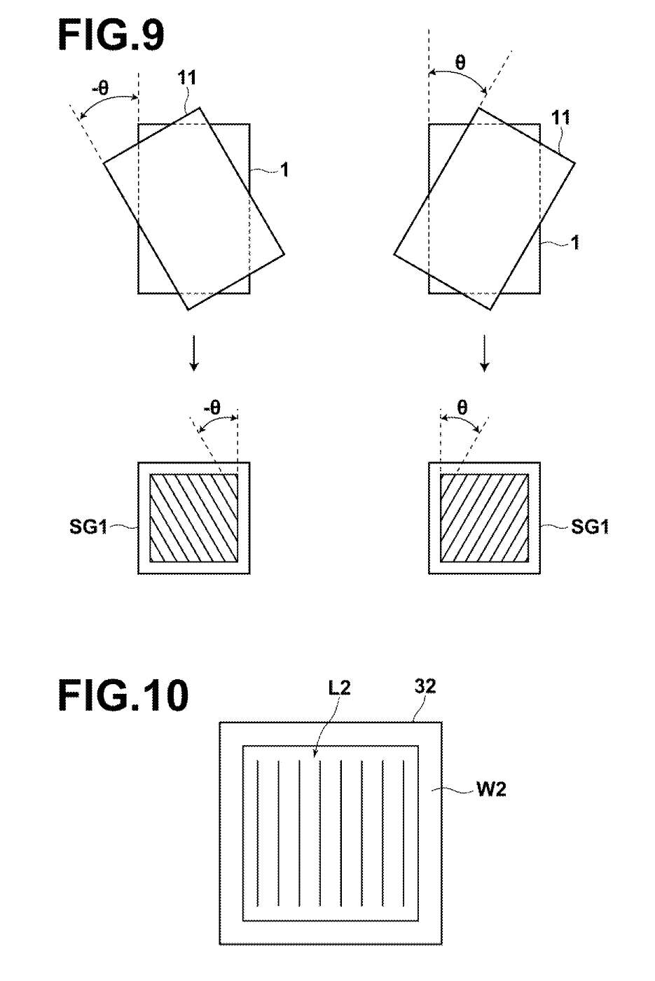

Second adjustment pattern 32 will now be described. FIG. 10 illustrates second adjustment pattern 32. Second adjustment pattern 32 is used to implement the alignment of image sheet 1 with lenticular sheet 11 in a pitch direction. As shown in FIG. 10, second adjustment pattern 32 includes frame W2 having a color different from that of first adjustment pattern 31 (e.g., yellow) and a plurality of line segments L2 arranged in the pitch direction of image units T0 of composite image G0.

The plurality of line segments L2 are arranged with a pitch identical to that of image units T0 and cylindrical lenses 12. The center line of line segments L2 is located at a position corresponding to that of the center line of image units T0 of composite image G0. For two adjustment patterns 32 located on the left and right of image area in FIG. 1, composite image G0 is virtually assumed and the center line of line segments L2 and the center line of image units T0 of virtually present composite image G0 are matched. When the pitch of image units T0 is P0, the line width of line segments L2 is set to about ½ of pitch P0. Hereinafter, the line width of line segments L2 will be described.

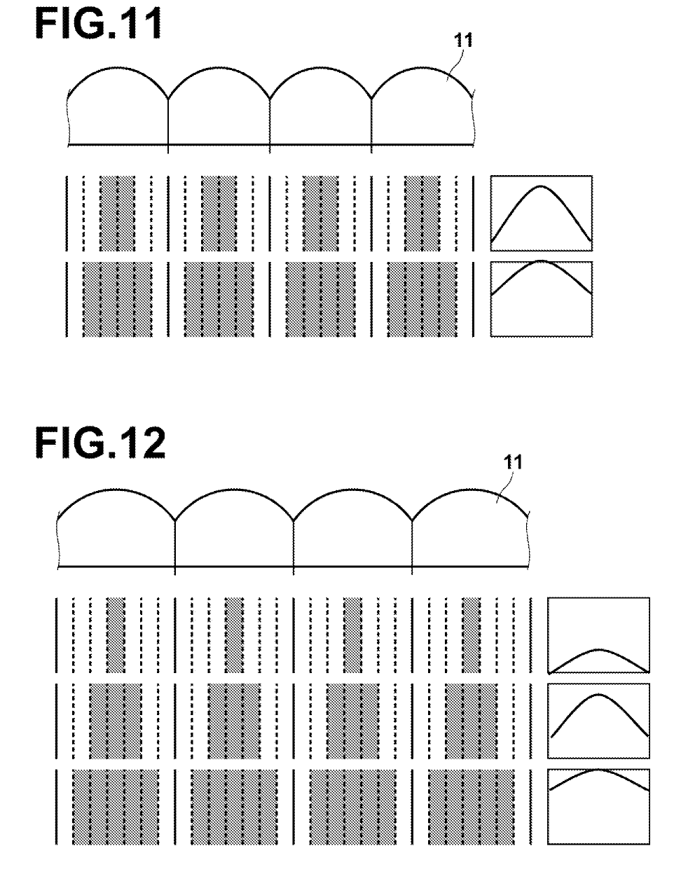

FIGS. 11 and 12 are drawings for explaining the line with of line segments L2 of second adjustment pattern 32. It is assumed that each image unit T0 in FIG. 11 includes six strip-like patterns and each image unit T0 in FIG. 12 includes seven strip-like patterns for the purpose of explanation. Further, a vertical direction in the drawings on the left side of FIGS. 11 and 12 corresponds to a longitudinal direction of image unit T0 and cylindrical lens 12, and solid lines represent delimiting lines of image units T0 and dotted lines represent delimiting lines of patterns within each image unit T0. Further, gray potions represent the line width of line segments L2. Drawings on the right side of FIGS. 11 and 12 are graphs indicating density changes of a portion of second adjustment pattern 32 viewed through lenticular sheet 11, with image sheet 1 and lenticular sheet 11 being placed on top of each other. In the density change graphs, the horizontal axis represents the shift amount in the pitch directions and the vertical axis represents the density.

When each image unit T0 includes six patterns as shown in FIG. 11, the line width can be changed to ⅓ P0 or ⅔·P0. In each case, when lenticular sheet 11 is moved in a pitch direction relative to image sheet 1, a position in second adjustment pattern 32 having a peak density can be confirmed, but the density change becomes greater when the line width is ⅓·P0.

When each image unit T0 includes seven patterns as shown in FIG. 12, the line width can be changed to 1/7·P0, 3/7·P0, or 5/7·P0. In each case, when lenticular sheet 11 is moved in a pitch direction relative to image sheet 1, a position in second adjustment pattern 32 having a peak density can be confirmed, but the density change becomes greater when the line width is 3/7·P0.

Consequently, in the second adjustment pattern, a displacement between image sheet 1 and lenticular sheet 11 in a pitch direction may be detected by the change in the density of line segments L2 viewed through lenticular sheet 11 regardless of the line width of line segments L2. But, when the line width of line segments L2 is substantially equal to ½ of pitch P0 of image units T0, the density change according to the amount of displacement of lenticular sheet in a pitch direction is more significant, as shown in FIGS. 11 and 12, so that the displacement of lenticular sheet in the pitch direction may be detected accurately. The displacement between image sheet 1 and lenticular sheet 11 in a pitch direction may be detected by analyzing the pattern image of second adjustment pattern 32, but the density change may also be visually confirmed.

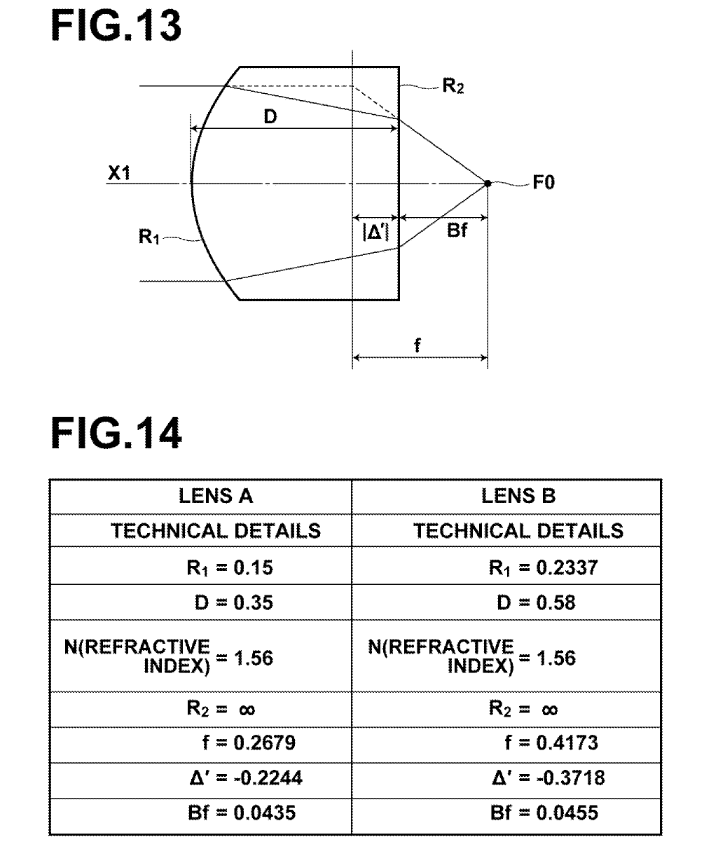

Here, technical details of cylindrical lens 12 of lenticular sheet used in the present embodiment will be described. FIG. 13 is a drawing for explaining the technical details of cylindrical lens 12. In FIG. 13, R1, R2 are the curvature radii of front and rear faces of cylindrical lens 12 respectively, D is the height of cylindrical lens 12, f is the focal length, Δ′ is the distance from the principal point to the rear surface, Bf is the back focus, and X1 is the optical axis.

FIG. 14 illustrates technical details of two types of cylindrical lenses A, B used in the present embodiment. The lens pitch of each of lenses A, B is 0.254 mm. It should be appreciated that not only lenticular sheet 11 having cylindrical lenses 12 with such technical details but also lenticular sheet 11 having cylindrical lenses with different technical details from those described above may be used in the present invention. Further, the pitches and line widths of first and second adjustment patterns 31, 32 may be changed according to the technical details of cylindrical lenses 12.

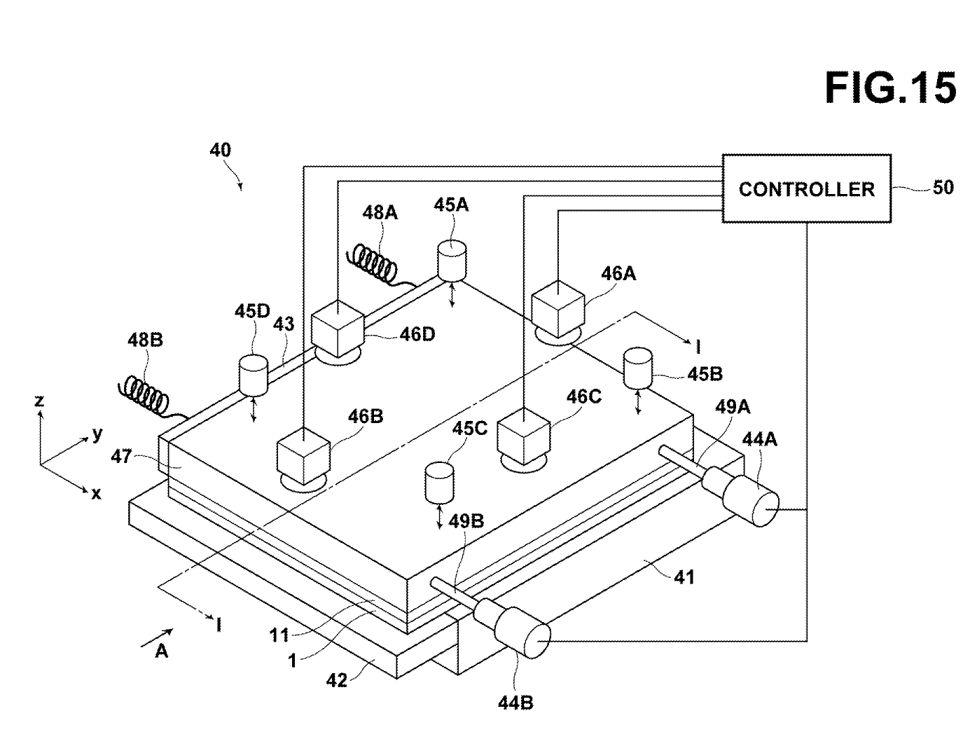

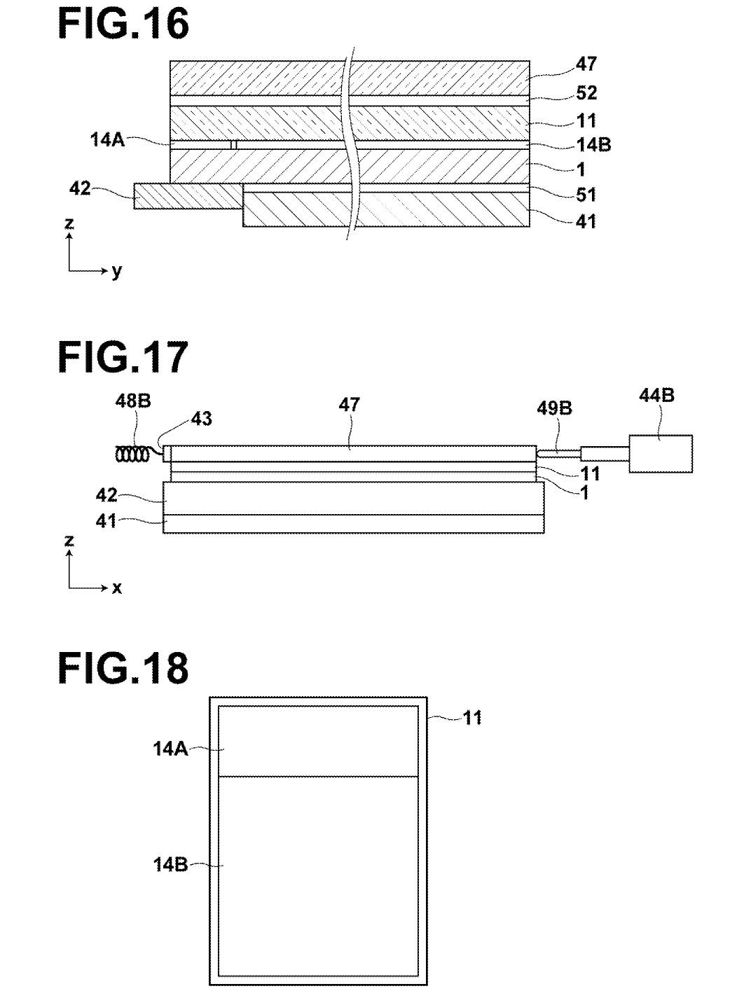

An alignment apparatus according to a first embodiment for performing alignment between image sheet 1 and lenticular sheet 11 will now be described. FIG. 15 is a schematic perspective view of the alignment apparatus of the present embodiment, illustrating the structure thereof. FIG. 16 a cross-sectional view taken along the line I-I in FIG. 15, and FIG. 17 is a view on arrow A in FIG. 15. As illustrated in FIGS. 15 to 17, Alignment apparatus 40 includes support platform 41, auxiliary platform 42, side face support member 43, adjustment motors 44A, 44B, clamps 45A to 45D, cameras 46A to 46D, transparent support member 47, and controller 50.

Support platform 41 is used to place image sheet 1 and lenticular sheet 11 stacked in this order with a pitch direction thereof being aligned with x direction. Support platform 41 has a silicon sheet 51 bonded to the upper surface thereof for increasing the frictional force between image sheet 1 and support platform 41 so that image sheet 1 is not shifted with respect to support platform 41 when alignment is performed. Transparent support member 47 is placed on lenticular sheet 11 for moving lenticular sheet 11 with respect to image sheet 1.

Transparent support member 47 is made of a transparent plate-like member having the same size as lenticular sheet 11. Note that an opaque plate-like member having openings or notches formed at positions corresponding to first and second adjustment patterns 31, 32 may be used instead of transparent support member 47. Further not only the plate-like member but also any known member may be used as long as it is capable of moving lenticular sheet 11 with respect to image sheet 1, to be described later. Transparent support member 47 has a transparent silicon sheet 52 bonded to the lower surface thereof for increasing the frictional force between lenticular sheet 11 and transparent support member 47 so that lenticular sheet 11 is not shifted with respect to transparent support member 47 when alignment is performed. Here, each of the friction coefficient f1 between transparent support member 47 with silicon sheet 52 bonded thereto and lenticular sheet 11 and friction coefficient f2 between the support platform 41 with silicon sheet 51 bonded thereto and image sheet 1 measured by the inventor of the present invention was about 1. Here, any known material capable of increasing the frictional force may be used other than silicon sheets 51, 52. Lenticular sheet 11 is formed of an acrylic resin.

In the mean time, lenticular sheet 11 includes a transparent adhesive on the lower surface thereof as an adhesive layer for bonding the lenticular sheet 11 to image sheet 1. Further two peel-off sheets 14A, 14B are attached to the adhesive layer for protection. FIG. 18 illustrates the peel-off sheets. As shown in FIG. 18, peel-off sheet 14A is shorter than peel-off sheet 14B in the vertical direction of FIG. 18.

Here, peel-off sheets 14A, 14B and image sheet 1 are papers, and the friction coefficient f3 between peel-off sheets 14A, 14B and image sheet 1 measured by the inventor of the present invention was about 0.3. Therefore, the relationship between friction coefficients f1 to f3 is f3<f1, f2.

Auxiliary platform 42 moves to a support position for supporting image sheet 1 and supports image sheet 1 with support platform 41 when alignment is performed, as illustrated in FIGS. 15 to 17. In the mean time, after the alignment is performed, auxiliary platform 42 is moved from the support position to a withdrawal position away from support platform 41 by a not shown moving mechanism.

Second ends of springs 48A, 48B, whose first ends are attached to a not shown base, are attached to side face support member 43 and side face support member 43 is moved by a not shown moving mechanism to abut a first side face (face on the left side in FIG. 17) of transparent support member 47 placed on support platform 41 and biases transparent support member 47 in +x direction in FIG. 15. Here, transparent support member 47 has silicon sheet 52 bonded to the lower surface thereof and the friction coefficient f1 between transparent support member 47 with silicon sheet 52 bonded thereto and lenticular sheet 11, and the friction coefficient f2 between the support platform 41 with silicon sheet 51 bonded thereto and image sheet 1 are greater than the friction coefficient f3 between peel-off sheets 14A, 14B and image sheet 1 as described above. Consequently, when transparent support member 47 is biased in +x direction, lenticular sheet 11 is also biased in +x direction with transparent support member 47.

Adjustment motors 44A, 44B are stepping motors and the operation thereof is controlled by controller 50, and pins 49A, 49B reciprocate in x axis direction according to the rotational direction thereof. Pins 49A, 49B are abutted to a second side face (face on the right side in FIG. 17) of transparent support member 47. Here, transparent support member 47 includes silicon sheet 52 bonded to the lower surface thereof, and the friction coefficient f1 between transparent support member 47 with silicon sheet 52 bonded thereto and lenticular sheet 11 and friction coefficient f2 between the support platform 41 and image sheet 1 are greater than the friction coefficient f3 between peel-off sheets 14A, 14B, i.e., lenticular sheet 11 and image sheet 1, as described above. Consequently, if pins 49A, 49B are moved in the same direction at the same time, transparent support member 47 is moved with respect to image sheet 1 in the same direction as the moving direction of pins 49A, 49B together with lenticular sheet 11 without image sheet 1 being displaced with respect to support platform 41. If only either one of pins 49A, 49B is moved or if pins 49A, 49B are moved in different directions at the same time, transparent support member 47 is rotated around z axis with respect to image sheet 1 together with lenticular sheet 11 without image sheet 1 being displaced with respect to support platform 41.

Clamps 45A to 45D may reciprocate in Z direction above the support platform 41 by a not shown moving mechanism, and are used to press transparent support member 47 downward after alignment, thereby fixing image sheet 1 and lenticular sheet 11 to support platform 41 so that lenticular sheet 11 is not displaced with respect to image sheet 1.

Cameras 46A to 46D are used to photograph first and second adjustment patterns 31, 32 disposed in pattern area 3 of image sheet 1 and to output image data of the pattern image to controller 50. These cameras are movable two-dimensionally in x and y directions above transparent support member 47 in FIG. 15 by a not shown moving mechanism. Cameras 46A, 46B photograph each set of first and second adjustment patterns 31, 32 disposed in the longitudinal direction of image area 2 in FIG. 1 respectively, while cameras 46C, 46D photograph second adjustment patterns disposed in the lateral direction of image area 2 in FIG. 1 respectively.

Controller 50 includes a not shown input unit, a not shown display unit, and the like, and analyses pattern images of first and second adjustment patterns 31, 32 and controls the operation of each unit of alignment apparatus 1.

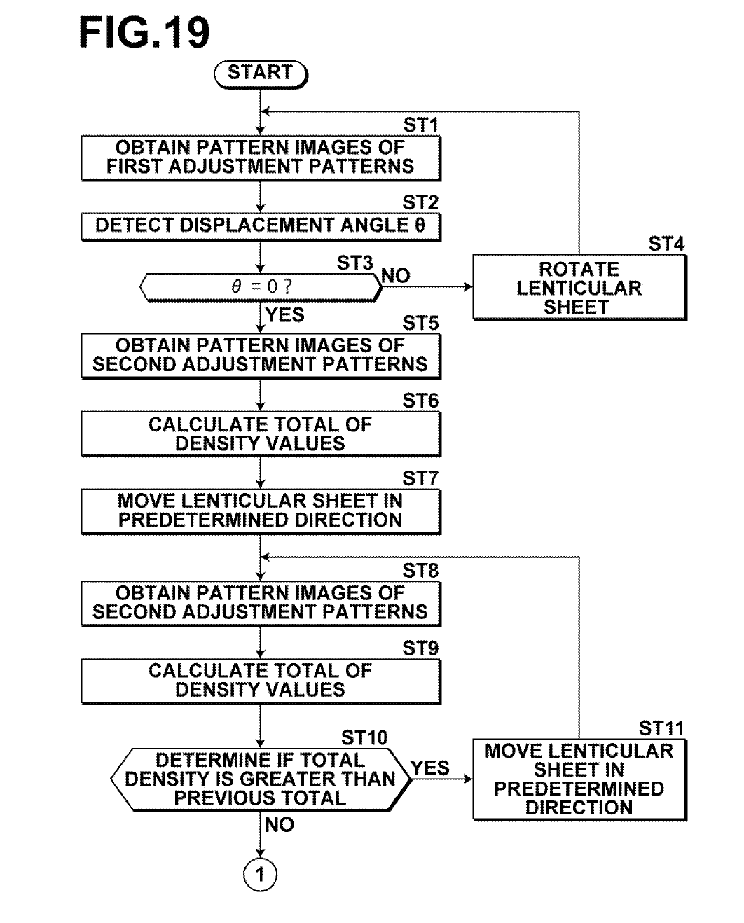

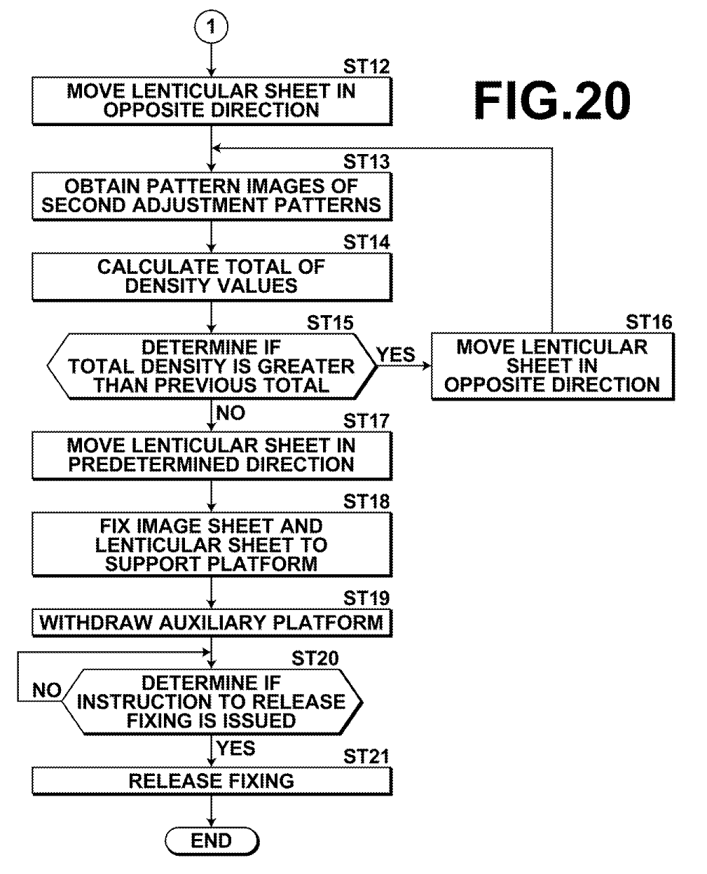

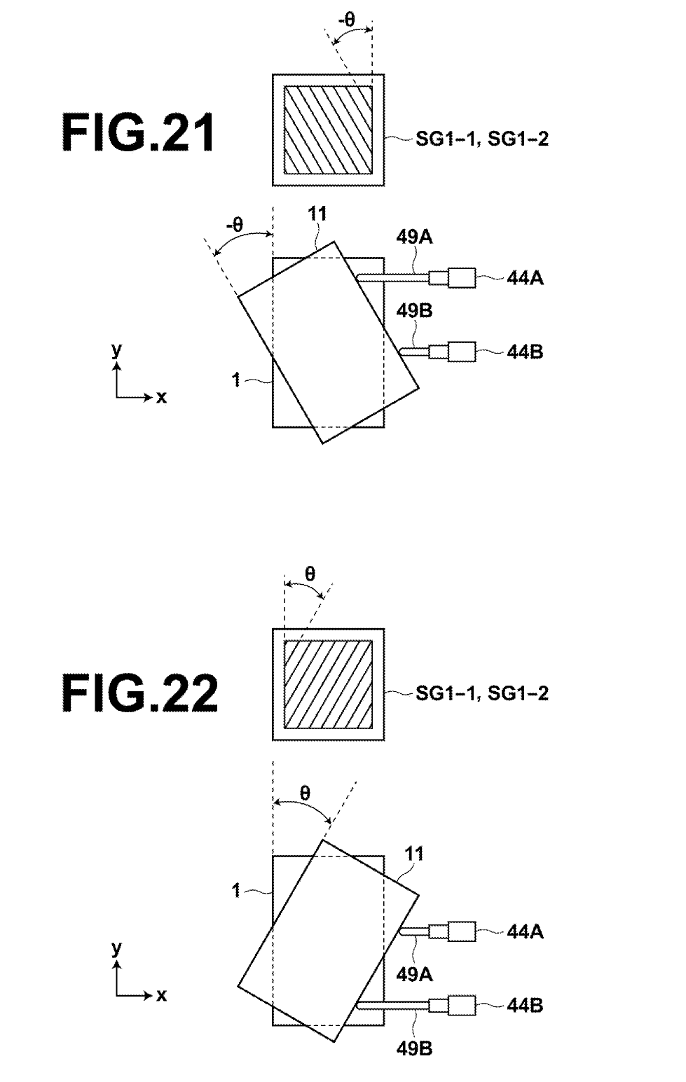

An operation of the alignment apparatus according to the present embodiment will now be described. FIGS. 19, 20 show a flowchart of an alignment process performed by alignment apparatus 1 in the present embodiment. Here, it is assumed that auxiliary platform 42 is already moved to the support position, and image sheet 1 and lenticular sheet 11 are stacked on top of each other after aligned to a certain extent and placed on support platform 41 and auxiliary platform 42 with peel-off sheet 14A facing the side of auxiliary platform 42, and transparent support member 47 is placed on lenticular sheet 11. Further, it is also assumed that side face support member 43 is abutted to the first side face of transparent support member 47 to bias transparent support member 47 in x direction, and pins 49A, 49B of adjustment motors 44A, 44B are abutted to the second side face of transparent support member 47.

First, controller 50 moves cameras 46A, 46B to first adjustment patterns 31 on image sheet 1 respectively and causes them to photograph first adjustment patterns 31 to obtain pattern images of first adjustment patterns 31 (step ST1). Note that first adjustment pattern 31 is disposed at two different positions in image sheet 1 so that two pattern images are obtained here. In this case, photographing is performed sequentially by each of cameras 46A, 46B while being moved by controller 50, then a blue frame is detected from pattern images by controller 50, and photographing is performed at each position where the blue frame is detected, whereby pattern images of first adjustment patterns 31 may be obtained.

Controller 50 detects an image of line segments L1 from each of the two pattern images (hereinafter, SG1-1, SG1-2) of first adjustment patterns 31 and detects displacement angle θ of line segments L1 described above (step ST2). Then, controller 50 determines whether or not the displacement angle θ becomes 0 in each of pattern images SG1-1, SG1-2 (step ST3). If step ST3 is negative, adjustment motors 44A, 44B are driven according to the displacement angle θ to change the positions of pins 49A, 49B, thereby rotating lenticular sheet 11 with respect to image sheet 1 by a predetermined amount (step ST4), and the process returns to step ST1 to repeat the processing from step ST1 onward.

FIGS. 21, 22 are drawings for explaining movement of pins 49A, 49B. Note that x direction and y direction in FIGS. 21, 22 correspond to x direction and y direction in FIG. 15. Note that, in FIGS. 21, 22, the advancing amounts of pins 49A, 49B are depicted greater than actual amounts to facilitate the explanation. As illustrated in FIG. 21, when line segments L1 are rotated by −θ with respect to y axis in each of pattern images SG1-1 and SG1-2 of first adjustment patterns 31, lenticular sheet 11 is rotated by −θ in the counterclockwise direction with respect to image sheet 1. Therefore, controller 50 controls adjustment motors 44A, 44B to cause pin 49A to be retreated and pin 49B to be advanced. Here, only pin 49A may be retreated or only pin 49B may be advanced.

In contrast, as illustrated in FIG. 22, when line segments L1 are rotated by θ with respect to y axis in each of pattern images SG1-1 and SG1-2 of first adjustment patterns 31, lenticular sheet 11 is rotated by θ in the clockwise direction with respect to image sheet 1. Therefore, controller 50 controls adjustment motors 44A, 44B to cause pin 49A to be advance and pin 49B to be retreated. Here, only pin 49A may be advance or only pin 49B may be retreated.

If step ST3 is positive, controller 50 moves cameras 46A to 46D to second adjustment patterns 32 and causes cameras 46A to 46D to photograph second adjustment patterns 32 to obtain pattern images of second adjustment patterns 32 (step ST5). Note that second adjustment pattern 32 is disposed at four different positions in image sheet 1 so that four pattern images are obtained here. In this case, photographing is performed sequentially by each of cameras 46A to 46D while being moved by controller 50, then a yellow frame is detected from pattern images by controller 50, and photographing is performed at each position where the yellow frame is detected, whereby pattern images of second adjustment patterns 32 may be obtained.

Controller 50 calculates the total of the density values of four pattern images (hereinafter, SG2-1, SG2-2, SG2-3, SG2-4) of second adjustment patterns 32 (step ST6). Then, pins 49A, 49B are moved in a predetermined direction of pitch directions (e.g., +x direction in FIG. 15) by a predetermined amount to move lenticular sheet 11 in the predetermined direction with respect to image sheet 1 (step ST7), and pattern images of second adjustment patterns 32 are further obtained (step ST8) and the total of the density values thereof is calculated (step ST9).

Then, a determination is made as to whether or not the total of the density values is greater than the previous total (step ST10). If stet ST10 is positive, pins 49A, 49B are moved in the predetermined direction by a predetermined amount to move lenticular sheet 11 in the predetermined direction with respect image sheet 1 (step ST11), and the process returns to step ST8 to repeat the processing from step ST8 onward. On the other hand, if step ST10 is negative, pins 49A, 49B are moved in the direction opposite to the predetermined direction by a predetermined amount to move lenticular sheet 11 in the direction opposite to the predetermined direction with respect to image sheet 1 (step ST12). Then pattern images of second adjustment patterns 32 are further obtained (step ST13) and the total of the density values is calculated by controller 50 (step ST14). Then a determination is made as to whether or not the total of the density values is greater than the previous totoal (step ST15). If step ST15 is positive, pins 49A, 49B are moved in the direction opposite to the predetermined direction by a predetermined amount to move lenticular sheet 11 in the direction opposite to the predetermined direction with respect to image sheet 1 (step ST16), and the process returns to step ST13 to repeat the processing from step ST13 onward. In the mean time, if step ST15 is negative, pins 49A, 49B are moved in the predetermined direction by a predetermined amount to move lenticular sheet 11 in the predetermined direction with respect to image sheet 1 (step ST17). This completes the alignment of image sheet 1 with lenticular sheet 11 in a pitch direction.

Then, controller 50 moves clamps 45A to 45D downward to press transparent support member 47 downward, thereby fixing image sheet 1 and lenticular sheet 11 to support platform 41 (step ST18), and causes auxiliary platform 42 to withdraw to the withdrawal position (step ST19). Under this state, if a portion of image sheet 1 which was placed on auxiliary platform 42 is tilted slightly downward, a boundary portion between peel-off sheets 14A, 14B of lenticular sheet 11 is exposed. This allows peel-off sheet 14A to be peeled off to bond image sheet 1 with a portion of lenticular sheet 11, whereby image sheet 1 and lenticular sheet 11 may be temporarily fixed. In this case, image sheet 1 and lenticular sheet 11 are fixed to support platform 41 so that any displacement does not occur between image sheet 1 and lenticular sheet 11.

Then, controller 50 starts monitoring whether or not an instruction to release the fixing of image sheet 1 and lenticular sheet 11 (step ST20) is issued, and if step ST20 is positive, moves clamps 45A to 45D upward to release the fixing of image sheet 1 and lenticular sheet 11 to support platform 41 (step ST21), and the process is completed.

Under this state, the operator removes image sheet 1, lenticular sheet 11, and transparent support member 47 from support platform 41, and further separates transparent support member 47 from image sheet 1 and lenticular sheet 11. Then, peel-off sheet 14B is peeled off from lenticular sheet 11 to fully bond image sheet 1 to lenticular sheet 11. In this case, image sheet 1 and a portion of lenticular sheet 11 is bonded so that any displacement does not occur between image sheet 1 and lenticular sheet 11.

After bonding image sheet 1 and lenticular sheet 11 together in the manner as described above, a portion corresponding to pattern area 3 of the image sheet is cut off to complete the manufacture of a lenticular print.

As described above, in the first embodiment, first adjustment patterns 31 for performing alignment with lentiduclar sheet 11 in a rotational direction and second adjustment patterns 32 for performing alignment with lentiduclar sheet 11 in a pitch direction in which image units T0 are arranged side by side are provided in pattern area 3 of image sheet 1. This allows accurate alignment of image sheet 1 with lenticular sheet 11 in rotational and pitch directions by stacking image sheet 1 and lenticular sheet 11 on to of each other and detecting first and second adjustment patterns 31, 32 through lenticular sheet 11. Further, as it is possible to photograph first and second adjustment patterns 31, 32, the alignment of image sheet 1 with lenticular sheet 11 can be automated easily.

Further, if first adjustment pattern 31 is formed of a plurality of line segments L1 arranged side by side in a pitch direction and if pitch P1 of the line segments a value that satisfies, when the pitch of the cylindrical lenses is P0, the relationship of P0<P1<2·P0, and more preferably if pitch P1 is about 4/3 of pitch P0 of the cylindrical lenses, the angular displacement in a rotational direction between image sheet 1 and lenticular sheet 11 may be detected by the inclination of line segments L1 included in first adjustment pattern 31 viewed through lenticular sheet 11. Consequently, image sheet 1 and lenticular sheet 11 may be aligned accurately with each other in a rotational direction by relatively rotating image sheet 1 and lenticular sheet 11 such that the inclination of the detected line segments becomes 0 with respect to a direction orthogonal to a pitch direction of the line segments.

Further, if second adjustment pattern 32 is formed of a plurality of line segments L2 arranged in a pitch direction with the same pitch as image units T0 at positions corresponding to substantially the centers of image units T0, and if line width of line segments L2 is set to about ½ of pitch P0 of image units T0, the displacement between image sheet 1 and lenticular sheet 11 in a pitch direction may be detected by the change in the density of line segments included in second adjustment pattern 32 viewed through lenticular sheet 11. Consequently, image sheet 1 may be aligned accurately with lenticular sheet 11 in a pitch direction by relatively moving image sheet 1 and lenticular sheet 11 such that the detected density is increased to a maximum.

Still further, alignment accuracy in a rotational direction and a pitch direction may be improved by providing pattern area 3 around image area 2 and disposing first and second adjustment patterns at positions on each side across image area 2 in a longitudinal direction thereof. Further, alignment accuracy in a pitch direction may further be improved by disposing second adjustment pattern 32 at a position on each side across image area 2 in a direction orthogonal to a longitudinal direction thereof.

Further, assignment of different colors to first and second adjustment patterns 31, 32 allows first and second adjustment patterns 31, 32 to be easily distinguished from each other when photographed so that the alignment may be automated more easily.

Still further, friction coefficient f1 between support platform 41 and image sheet 1 and friction coefficient f2 between transparent support member 47 and lenticular sheet 11 are set greater than the friction coefficient f3 between image sheet 1 and lenticular sheet 11, so that any displacement does not occur between transparent support member 47 and lenticular sheet 11 or between support platform 41 and image sheet 1 when transparent support member 47 is moved at the time of alignment. Accordingly, while image sheet 1 is kept in a state of being fixed to support platform, lenticular sheet 11 may be moved integrally with transparent support member 47 with respect to image sheet 1. Consequently, image sheet 1 and lenticular sheet 11 may be aligned with each other with a simple configuration.

Further, as silicon sheets 51, 52 are bonded to a surface of support platform 41 on which image sheet 1 is placed and a surface of transparent support member 47 that contacts lenticular sheet 11 respectively, any displacement between transparent support member 47 and lenticular sheet 11 or between support platform 41 and image sheet 1 may be reliably prevented.

Still further, image sheet 1 and lenticular sheet 11 may be stably supported when aligning them by moving auxiliary platform 42 to the support position. In addition, auxiliary platform 42 may be moved to a withdrawal position after the alignment and image sheet 1 may be bonded to a portion of lenticular sheet 11 at the position where auxiliary platform 42 was positioned, which may thus facilitate the partial bonding between image sheet 1 and lenticular sheet 11.

Further, image sheet 1 and lenticular sheet 11 placed on support patform 41 may be pressed by way of transparent support member 47 to fix them on support patform 41, so that any displacement between image sheet 1 and lenticular sheet 11 may be prevented when performing the partial bonding between them.

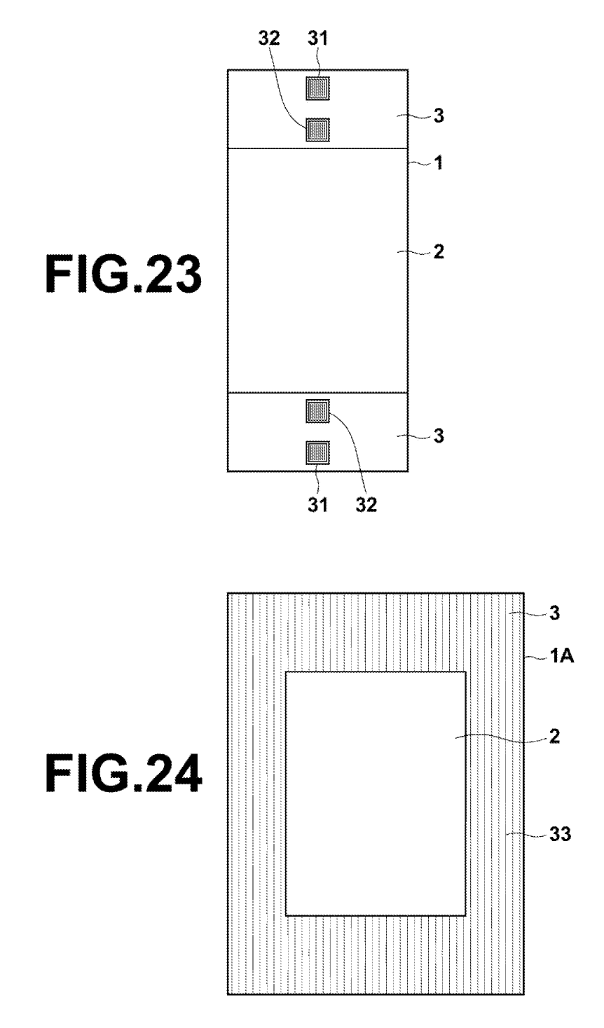

In the embodiment described above, the pattern area is provided around image area 2 of image sheet 1, but two separate pattern areas 3 may be provided across image area 2, as shown in FIG. 23. In this case, it is preferable that two pattern areas 3 are provided across image area 2 in a longitudinal direction thereof, and first and second adjustment patterns 31, 32 are disposed in each pattern area 3. This may reduce a wasted area to be cut off when making a lenticular print.

Further, in the embodiment described above, image sheet 1 and lenticular sheet 11 are aligned with each other by photographing first and second adjustment patterns 31, 32 and analyzing pattern images obtained by the photographing in alignment apparatus 40, but the alignment may be performed by the operator by visually confirming first and second adjustment patterns 31, 32. Further, lenticular sheet 11 may be moved manually by the operator.

Still further, in the embodiment described above, the operator performs bonding between image sheet 1 and lenticular sheet 11 after aligned by peeling off peel-off sheets 14A, 14B in alignment apparatus 40, but a mechanism for peeling off peel-off sheets 14A, 14B may be provided to peel them off automatically.

Further, in the embodiment described above, first and second adjustment patterns 31, 32 are provided with frames W1, W2 respectively and different colors are assigned, but different colors may be assigned to the backgrounds of line segments L1, L2 or to line segments L1, L2 without proving frames W1, W2. Further, first and second adjustment patterns 31, 32 may not be assigned any color.

Hereinafter, a second embodiment of the present invention will be described. FIG. 24 is a plan view of an image sheet according to the second embodiment of the present invention. In the second embodiment, elements identical to those of the first embodiment are given the same reference numerals and will not be elaborated upon further here. Image sheet 1A according to the second embodiment differs from image sheet 1 according to the first embodiment in that it includes line segments, as adjustment pattern 33, disposed over the entire surface of pattern area 3 with the same pitch as line segments L2 of second adjustment pattern 32. Note that the center line of line segments of adjustment pattern 33 corresponds to the center line of image units T0 of composite image G0.

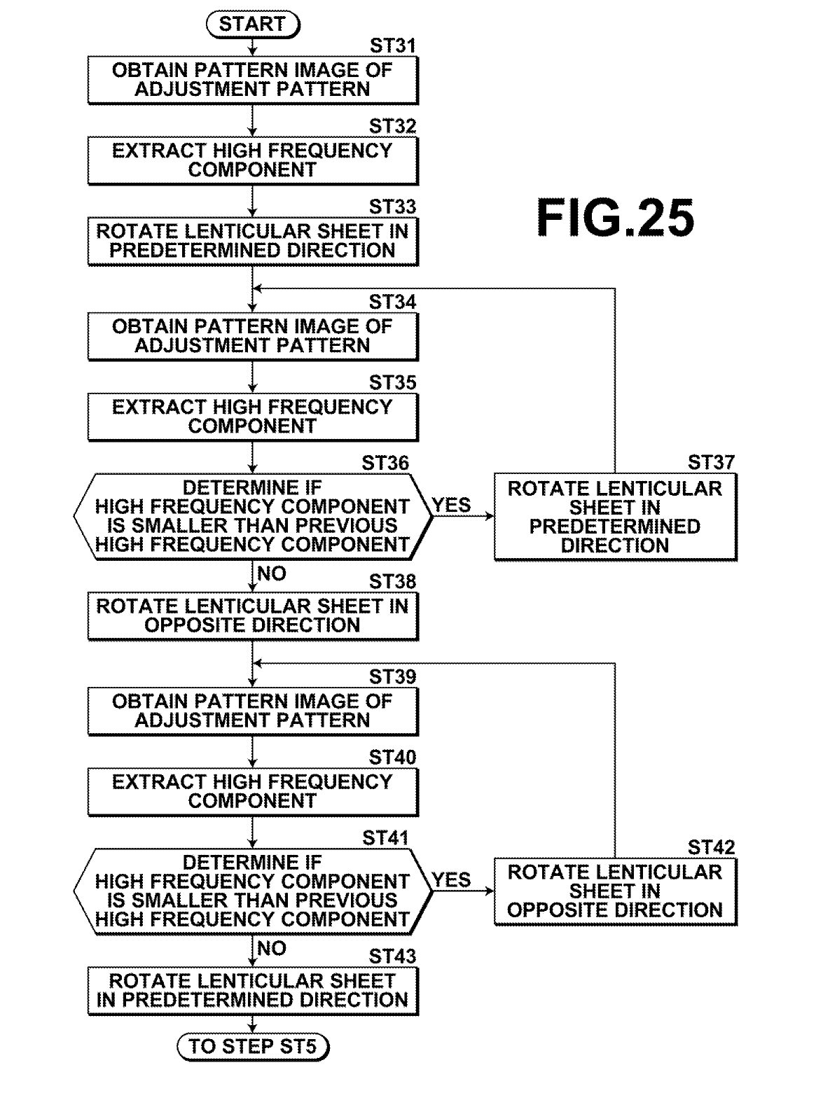

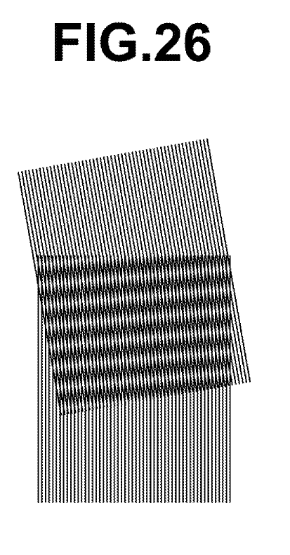

Next, alignment of image sheet 1A of the second embodiment with lenticular sheet 11 will be described. The alignment apparatus that performs alignment of image sheet 1A of the second embodiment with lenticular sheet 11 differs from the alignment apparatus shown in FIGS. 15 to 17 in that it uses only one camera. Therefore, it will not be elaborated upon further here. FIG. 25 is a flowchart of an alignment process performed by alignment apparatus 1 using image sheet 1A of the second embodiment. Note that, in the second embodiment, only camera 46A is used.

First, controller 50 moves camera 46A to a predetermined position in pattern area 3 of image sheet 1A and causes the camera to photograph adjustment pattern 33 to obtain a pattern image of adjustment pattern 33 (step ST31). Then, controller 50 extracts a high frequency component of the pattern image of adjustment pattern 33 (step ST32). As for the extraction of high frequency component, any known process, such as filtering process using a high-pass filter, Fourier transform, wavelet transform, or the like, may be used. Here, if image sheet 1A and lenticular sheet 11 are displaced in a rotational direction, a moiré pattern is generated in pattern area 3 viewed through lenticular sheet 11. Here, in the pattern image, a greater displacement angle results in a greater amount of the high frequency component due to moiré. Consequently, controller 50 controls adjustment motors 44A, 44B to change the positions of pins 49A, 49B, thereby rotating lenticular sheet 11 in a predetermined direction with respect to image sheet 1A by a predetermined amount (step ST33), the further obtains a pattern image of adjustment pattern 33 (step ST34), and extracts a high frequency component of the pattern image of adjustment pattern 33 (step ST35).

Then, a determination is made as to whether or not the high frequency component is greater than the previous high frequency component (step ST36). If step ST36 is positive, pins 49A, 49B are moved to rotate lenticular sheet 11 in the predetermined direction with respect to image sheet 1A by a predetermined amount (step ST37), and the process returns to step ST34 to repeat the processing from step ST34 onward. On the other hand, if step ST36 is negative, pins 49A, 49B are driven to rotate lenticular sheet 11 in the direction opposite to the predetermined direction with respect to image sheet 1A by a predetermined amount (step ST38). Controller further obtains a pattern image of adjustment pattern 33 (step ST39) and extracts a high frequency component of the pattern image of adjustment pattern 33 (step ST40). Then, a determination is made as to whether or not the high frequency component is greater than the previous high frequency component (step ST41). If step ST41 is positive, pins 49A, 49B are moved to rotate lenticular sheet 11 in the direction opposite to the predetermined direction with respect to image sheet 1A by a predetermined amount (step ST42), and the process returns to step ST39 to repeat the processing from step ST39 onward. On the other hand, if step ST41 is negative, pins 49A, 49B are driven to rotate lenticular sheet 11 in the predetermined direction with respect to image sheet 1A by a predetermined amount (step ST43). This completes the alignment of image sheet 1A with lenticular sheet 11 in a rotational direction.

Thereafter, the process proceeds to step ST5 of the flowchart shown in FIGS. 19 and 20 to perform processing identical to the processing from step ST5 onward, whereby image sheet 1A and lenticular sheet 11 are aligned in a pitch direction. Then, image sheet 1A and lenticular sheet 11 are bonded together to produce a lenticular print. Note that in the processing from step ST5 onward, step ST5 changes from obtaining of pattern images of second adjustment patterns 32 to obtaining of a pattern image of adjustment pattern 33.

As described above, use of image sheet 1A according to the second embodiment also allows image sheet 1A and lenticular sheet 11 to be aligned with each other easily in rotational and pitch directions. Further, it is not necessary to search for first and second adjustment patterns 31, 32, as in the first embodiment, the configuration of alignment apparatus may be simplified.

Further, in the second embodiment, image sheet 1A is aligned with lenticular sheet 11 by photographing adjustment pattern 33 and analyzing a pattern image obtained by the photographing in alignment apparatus 40, but the alignment may be performed by the operator by visually confirming the high frequency component and density of adjustment pattern 33. Further, lenticular sheet 11 may be moved manually by the operator.

What is claimed is:

1. An image sheet to be provided with a composite image which can be viewed stereoscopically or changeably when bonded to a lenticular sheet having a plurality of cylindrical lenses arranged in parallel, the composite image including a plurality of image units arranged side by side, each corresponding to each of the cylindrical lenses and having a plurality of strip-like images, wherein the image sheet comprises:
an image area to be provided with the composite image; and
a pattern area to be provided with at least one first adjustment pattern and at least one second adjustment pattern for aligning the image sheet with the lenticular sheet in a rotational direction and a pitch direction, in which the image units are arranged, respectively.

2. The image sheet of claim 1, wherein the first adjustment pattern comprises a plurality of line segments arranged in the pitch direction and a pitch P1 of the line segments satisfies, when the pitch of the image units is P0, the relationship of P0<P1<2·P0.

3. The image sheet of claim 2, wherein the pitch P1 of the line segments is about 4/3 of the pitch P0 of the image units.

4. The image sheet of claim 1, wherein the second adjustment pattern includes a plurality of line segments arranged in the pitch direction with the same pitch as the image units at positions corresponding to substantially the centers of the image units, and a line width of each of the line segments is about ½ of the pitch P0 of the image units.

5. The image sheet of claim 1, wherein the pattern area is provided around the image area, and first and second adjustment patterns are provided at positions on each side across the image area in a longitudinal direction of the image area.

6. The image sheet of claim 5, wherein the second adjustment pattern is provided at a position on each side across the image area in a direction orthogonal to the longitudinal direction.

7. The image sheet of claim 1, wherein the pattern area is divided into two areas across the image area in the longitudinal direction of the image area, and the first and second adjustment patterns are provided in each of the two areas.

8. The image sheet of claim 1, wherein the first and second adjustment patterns are assigned different colors.

9. An alignment apparatus for aligning the image sheet of claim 1 with a lenticular sheet having a plurality of cylindrical lenses arranged in parallel, the apparatus comprising:
a photographing unit for photographing an image of the first adjustment pattern appeared on the lenticular sheet stacked on the image sheet;
a detection unit for detecting an angle of the line segments with respect to a longitudinal direction of the image units in the image of the first adjustment pattern obtained by the photographing; and
a moving unit for rotating the lenticular sheet with respect to the image sheet such that the angle is reduced to a minimum to align the image sheet with the lenticular sheet in the rotational direction.

10. The alignment apparatus of claim 9, wherein:
the photographing unit is a unit that photographs an image of the second adjustment pattern appeared on the lenticular sheet stacked on the image sheet after the alignment in the rotational direct;
the detection unit is a unit that detects a density of the line segments in the image of the second adjustment pattern obtained by the photographing; and
the moving unit is a unit that moves the lenticular sheet with respect to the image sheet in a pitch direction of the cylindrical lenses such that the density is increased to a maximum to align the image sheet with the lenticular sheet in the pitch direction.

11. An alignment method for aligning the image sheet of claim 1 with a lenticular sheet having a plurality of cylindrical lenses arranged in parallel, the method comprising the steps of:
photographing an image of the first adjustment pattern appeared on the lenticular sheet stacked on the image sheet;
detecting an angle of the line segments with respect to a direction in which the image units extend in the image of the first adjustment pattern obtained by the photographing; and
rotating the lenticular sheet with respect to the image sheet such that the angle is reduced to a minimum to align the image sheet with the lenticular sheet in the rotational direction.

12. An image sheet to be provided with a composite image which can be viewed stereoscopically or changeably when bonded to a lenticular sheet having a plurality of cylindrical lenses arranged in parallel, the composite image including a plurality of image units arranged side by side, each corresponding to each of the cylindrical lenses and having a plurality of strip-like images, wherein the image sheet comprises:
an image area to be provided with the composite image; and
a pattern area to be provided over the entire surface with an adjustment pattern for aligning the image sheet with the lenticular sheet.

13. The image sheet of claim 12, wherein the adjustment pattern includes a plurality of line segments arranged in the pitch direction with the same pitch as the image units at positions corresponding to substantially the centers of the image units, and a line width of each of the line segments is about ½ of the pitch P0 of the image units.

14. An alignment apparatus for aligning the image sheet of claim 12 with a lenticular sheet having a plurality of cylindrical lenses arranged in parallel, the apparatus comprising:
a photographing unit for photographing an image of the adjustment pattern appeared on the lenticular sheet stacked on the image sheet;
a detection unit for detecting a high frequency component of the image of the adjustment pattern obtained by the photographing; and
a moving unit for rotating the lenticular sheet with respect to the image sheet such that the high frequency component is reduced to a minimum to align the image sheet with the lenticular sheet in the rotational direction.

15. The alignment apparatus of claim 14, wherein:
the photographing unit is a unit that photographs an image of the adjustment pattern appeared on the lenticular sheet stacked on the image sheet after the alignment in the rotational direct;
the detection unit is a unit that detects a density of the line segments in the image of the adjustment pattern obtained by the photographing; and
the moving unit is a unit that moves the lenticular sheet with respect to the image sheet in a pitch direction of the cylindrical lenses such that the density is increased to a maximum to align the image sheet with the lenticular sheet in the pitch direction.

16. An alignment method for aligning the image sheet of claim 12 with a lenticular sheet having a plurality of cylindrical lenses arranged in parallel, the method comprising the steps of:
photographing an image of the adjustment pattern appeared on the lenticular sheet stacked on the image sheet;
detecting a high frequency component of the image of the adjustment pattern obtained by the photographing; and
rotating the lenticular sheet with respect to the image sheet such that the high frequency component is reduced to a minimum to align the image sheet with the lenticular sheet in the rotational direction.

17. An alignment apparatus for aligning a composite image, which can be viewed stereoscopically or changeably when bonded to a lenticular sheet having a plurality of cylindrical lenses arranged in parallel, with the lenticular sheet, the composite image including a plurality of image units arranged side by side, each corresponding to each of the cylindrical lenses and having a plurality of strip-like images, the apparatus comprising:
a support platform on which the image sheet and the lenticular sheet are placed in a stacked manner in this order;
a support member for supporting the image sheet and the lenticular sheet placed on the support platform from above; and
a moving unit for relatively moving the lenticular sheet with respect to image sheet by moving the support member,
wherein a friction coefficient between the support platform and the image sheet and a friction coefficient between the support member and the lenticular sheet are greater than a friction coefficient between the image sheet and the lenticular sheet.

18. The alignment apparatus of claim 17, wherein a high friction coefficient member is attached to a surface of the support platform on which the image sheet is placed and a surface of the support member that contacts the lenticular sheet.

19. The alignment apparatus of claim 17, further comprising an auxiliary platform on which, together with the support platform, the image sheet is placed, and is capable of moving between a support position for supporting the image sheet and a withdrawal position away from the support platform.

20. The alignment apparatus of claim 19, further comprising a fixing unit for fixing the image sheet and the lenticular sheet to the support platform by pressing the image sheet and the lenticular sheet placed on the support platform by way of the support member.

21. The alignment apparatus of claim 17, wherein the lenticular sheet includes an adhesive layer and a peel-off sheet for protecting the adhesive layer on the lower surface, and the image sheet and the lenticular sheet are stacked on top of each other with the peel-off sheet facing the image sheet.

22. An alignment method for aligning a composite image, which can be viewed stereoscopically or changeably when bonded to a lenticular sheet having a plurality of cylindrical lenses arranged in parallel, with the lenticular sheet, the composite image including a plurality of image units arranged side by side, each corresponding to each of the cylindrical lenses and having a plurality of strip-like images, the method comprising the steps of:
placing the image sheet and the lenticular sheet on a support platform by stacking them on top of each other in this order;
supporting the image sheet and the lenticular sheet placed on the support platform with a support member from above; and
relatively moving the lenticular sheet with respect to image sheet by moving the support member,
wherein a friction coefficient between the support platform and the image sheet, and a friction coefficient between the support member and the lenticular sheet are greater than a friction coefficient between the image sheet and the lenticular sheet.
